(19) United States
(12) Patent Application Publication
(10) Pub. No.: US 2022/0347847 A1
(43) Pub. Date: Nov. 3, 2022

(54) Methods for Learning Parameters of a Neural Network, for Generating a Trajectory of an Exoskeleton and for Setting the Exoskeleton in Motion

(71) Applicant: WANDERCRAFT, PARIS (FR)

(72) Inventors: Alexis DUBURCQ, PARIS (FR); Yann CHEVALEYRE, PARIS (FR); Guilhem BOERIS, PARIS (FR)

(21) Appl. No.: 17/760,895

(22) PCT Filed: Sep. 25, 2020
(86) PCT No.: PCT/FR2020/051672

§ 371 Date: Mar. 16, 2022

(30) Foreign Application Priority Data
Sep. 26, 2019 (FR) FR1910649

(51) Int. Cl. B25J 9/16; B25J 9/00

(52) U.S. Cl. CPC B25J 9/1664; B25J 9/0006; B25J 9/163

(57) ABSTRACT

The present invention relates to a method for learning parameters of a neural network for generating trajectories of an exoskeleton (1), the method comprising the implementation, by data processing means (11a) of a first server (10a), of steps of:
(a) Learning parameters of a first neural network suitable for generating periodic elementary trajectories of the exoskeleton (1) each for a given walking of the exoskeleton (1) defined by a n-tuple of walking parameters, according to a first database for learning periodic trajectories for a set of possible walkings of the exoskeleton (1);
(b) Learning, using parameters from the first neural network, parameters of a second neural network suitable for generating periodic elementary trajectories of the exoskeleton (1) and transitions from one periodic elementary trajectory of the exoskeleton (1) to another periodic elementary trajectory of the exoskeleton (1), according to a second learning database of periodic elementary trajectories and transitions for a set of possible walkings of the exoskeleton (1).

### GENERAL TECHNICAL FIELD

The present invention relates to the field of robots of the exoskeleton type. More precisely, it relates to methods for learning parameters of a neural network, for using the neural network for generating a trajectory of an exoskeleton, and for setting the exoskeleton in motion.

### STATE OF THE ART

Recently, for persons with substantial mobility problems such as paraplegics, assisted walking devices called exoskeletons have appeared, which are external robotic devices that the operator (the human user) “puts on” thanks to a system of fasteners that links the movements of the exoskeleton with their own movements. Exoskeletons for the lower limbs have several articulations, generally at least at the knees and hips, in order to reproduce the movement of walking. Actuators make it possible to move these articulations, which in turn move the operator. An interface system allows the operator to give orders to the exoskeleton, and a control system transforms these orders into commands for the actuators. The device is generally supplemented with sensors.

These exoskeletons constitute progress with respect to wheelchairs, because they allow operators to stand up and walk. Exoskeletons are no longer limited by wheels and can theoretically move about in most environments that are not flat: wheels, contrary to legs, do not make it possible to cross substantial obstacles such as steps, staircases, obstacles with an excessively high height, etc.

However, in their usage, none of these exoskeletons carries out autonomous human walking, i.e. stable and viable over a wide variety of terrains, and that is anthropomorphic and unassisted.

In most cases, these limitations are materialised by the impossibility for the device to manage the balance or the walking direction by itself. These two tasks are then generally transferred to the operator, who performs them thanks to crutches, as proposed for example in patent U.S. Pat. No. 7,153,242 of Rewalk, or in application US2016038371 of Ekso-Bionics.

Patent EP2231096 of Rex-Bionics describes the only exoskeleton that can be used without outside assistance for a person that is uncapable of ensuring their own stability. The control principle, described in paragraph [0122], clearly explains the need to transfer the centre of pressure (the physical point that corresponds to the resultant of the reaction forces exerted by the ground on the system) of a portion of the support polygon (the convex envelope of the points of contact with the ground) to another portion of the support polygon.

This limitation imposes extremely slow walking (a few metres per minute, although normal walking exceeds 2 km/h) with short steps (less than 30 cm, although a normal stride ranges from 50 to 80 cm), during which the supporting foot is constantly in flat contact with the ground. The type of environment that can be accessed is therefore limited, since uneven terrains are excluded in fact. Likewise, the slightest obstacle such as a pebble, a small object, generates a risk of unbalancing the system if it places its foot on it at a given moment, and finally causing it to fall.

In opposition, “natural” human walking is characterised by a succession of phases during which the feet can be flat on the ground, in the air, or in the process of rolling on the ground. This capacity of rolling the foot is essential for walking because it makes it possible to take larger steps and allows for stability on a large variety of terrains.

However the so-called first generation exoskeletons described hereinabove do not have actuated feet or keep the supporting foot on the ground.

Carrying out this rolling is indeed complex for bipedal humanoid robots or robotic devices. When the centre of pressure reaches the limit of the support polygon, the system starts to roll around this point, and is therefore no longer in static equilibrium.

In the case of walking, the rolling of the foot implies a partial loss of contact with the ground at the supporting foot, with several consequences:
the support polygon (the sustentation surface) is reduced, potentially to a point, making it difficult and even impossible to maintain the centre of pressure inside the support polygon;
the system is in a situation of under-actuation, i.e. it can no longer act on all of its degrees of freedom. All the movements are then no longer possible.

In such a situation, the conventional formalism of walking with flat feet such as described in the document Kajita S., K. F. (2003), Biped Walking pattern generation by using preview control of Zero-Moment Point. ICRA, (pp. 1620-1626), or the principle described in the patent Rex-Bionics EP2231096 can no longer work.

A natural idea is to bring the swinging leg in front and to place the second foot on the ground in order to return to a support polygon and balance, this while the system is in free rotation around the supporting foot, in a manner of speaking in the process of “falling”. This is then called dynamic walking, since the body goes through a succession of unstable postures, but only as a transition (if the person were to be “stopped” on the fly they would fall).

In this approach of dynamic walking, bringing the swinging leg quickly to a position that re-establishes the balance at least briefly is complicated. Indeed, if this foot is made to follow a trajectory parameterised in precalculated time, this foot risks hitting the ground too early or too late due to the uncontrollable behaviour of the under-actuated system even when subjected to slight disturbances (it is not possible to correct a trajectory that would deviate slightly from that which was planned). This can generate discomfort for the operator, unbalance the operator or even cause them to fall, including on simple terrains.

It is for this that all first-generation exoskeletons (and many humanoid robots) try to avoid this type of situation by keeping the supporting foot flat, with for consequences the aforementioned limitations on the walking speed, the length of the steps, the permissible type of terrain and the general stability of the walking.

A new walking paradigm for exoskeletons was consequently proposed in application WO2018130784, combining the principles of “virtual constraints” and of “Hybrid Zero Dynamics” (HZD) allow for fast and natural walking, and without the risk of falling or imbalance even on difficult and unforeseen terrain.

Conventionally, trajectories, i.e. the changes with each degree of freedom, are expressed as a function of time. The “dynamics” of the system is defined by a function

f:χ×U×R⁺=χ

and a starting point

ζ∈χ

the function f is written

\acute{x}ₜ=f(xₜ, uₜ, t), x₀=ζ

χ being the state space of the exoskeleton 1, U the control space, and t representing time.

The HZD is on the contrary the dynamics of the degrees of freedom that are not actuated. This dynamics is called “Zero” since it corresponds to the degrees on which the command cannot or does not want to act upon, i.e. the command is worth 0, and “Hybrid” because the impact of the foot on the ground imposes discontinuous instantaneous phases that intersect the continuous phases.

In the so-called “virtual constraints” method, the principle is to define for a selection of actuated degrees of freedom a trajectory parameterised by a change parameter and not by time, but directly according to the configuration, this parameter being named phase variable. An example of such a phase variable is the angle between the heel-hip axis and the vertical which then constitutes a degree of freedom that is not actuated mentioned hereinabove.

The phase variable makes it possible to define the “progress” of a step. More precisely, at each step, the phase variable continuously switches from an initial value to a final value, before being reassigned the initial value: this is the beginning of the following step. To make things easier, it is possible to normalise the value of the phase parameter between 0 and 1.

To each value of the change parameter corresponds a value of the actuated degrees of freedom that the system must seek to follow: it is these relationships (one for each actuated degree of freedom that are desired to be controlled in this way) that are named virtual constraints.

If the system exactly follows this trajectory for the degrees of freedom on which it is possible and desired to act, in other terms if the virtual constraints are complied with for these degrees of freedom, then the change of the system is entirely determined by these degrees of freedom that are not actuated which follow their own dynamics which is HZD.

A good choice of virtual constraints can thus bring this dynamics to contain an attractive periodic “orbit”, i.e. a stable trajectory towards which the system is naturally attracted.

This HZD method provides great satisfaction, but the difficulty resides in generating trajectories (this is moreover also the case on the “flat foot” method). Indeed, a given trajectory is associated with “characteristics” of the walking, such as the length of the steps, the walking frequency and the inclination of the bust, but also the height of the steps in the case of negotiating stairs, the instantaneous angle of rotation for curved movements, the position of the centre of mass and the lateral deviation of the bust in the framework of the activity of rehabilitation, and has to be stable. If the characteristics of the walking change, a new trajectory is required.

Today, there is no solution that makes it possible to generate a trajectory in real time, it is necessary to pre-calculate them and test them, and this for several reasons:
The current trajectory-generating algorithm is based on a method for optimising for non-linear non-convex problems under constraints. This type of algorithm does not have any guarantee of convergence. It is therefore impossible to confirm to be able to obtain a trajectory for the desired walking characteristics, even when being limited to a search space that is mathematically compact.
Resolving such non-linear non-convex problems under constraints is complex and requires substantial computational power. Approximately 90s of computational time is required per trajectory per physical core on a high-end computer, although this time would have to be about 100 μs in order to consider real-time operation.
Currently, the calculations are performed on a remote server then the results are transferred by internet, which forces the users of the exoskeleton to have a permanent stable connection, which represents significant inconvenience for use in daily life.

Thus, it would be desirable to have a new solution for generating trajectories that can finally be implemented in real time, and without the slightest risk for the operator of the exoskeleton.

### PRESENTATION OF THE INVENTION

The present invention thus relates according to a first aspect to a method for learning parameters of a neural network for generating trajectories of an exoskeleton, the method comprising the implementation, by data processing means of a first server, of steps of:
(a) Learning parameters of a first neural network suitable for generating periodic elementary trajectories of the exoskeleton each for a given walking of the exoskeleton defined by a n-tuple of walking parameters, according to a first database for learning periodic trajectories for a set of possible walkings of the exoskeleton;
(b) Learning, using parameters from the first neural network, parameters of a second neural network suitable for generating periodic elementary trajectories of the exoskeleton and transitions from one periodic elementary trajectory of the exoskeleton to another periodic elementary trajectory of the exoskeleton, according to a second learning database of periodic elementary trajectories and transitions for a set of possible walkings of the exoskeleton.

According to other advantageous and non-limiting characteristics:

The step (a) comprises the construction of said first learning database of periodic trajectories for a set of possible walkings of the exoskeleton by using an optimisation algorithm.

Said set of possible walkings of the exoskeleton is chosen in such a way as to uniformly cover the space wherein said n-tuple of step parameters has value.

The step (a) further comprises the verification of a criterion representative of the accuracy of the predictions of the first neural network, and if this criterion is not verified the step (a) is repeated.

The step (b) comprises the construction of said second database for learning periodic trajectories and transitions for a set of possible walkings of the exoskeleton using the first learning database.

Said second database comprises all the transitions from a periodic elementary trajectory of the exoskeleton of the first learning database to another periodic elementary trajectory of the exoskeleton of the first learning database.

Each transition from a periodic elementary trajectory of the exoskeleton, referred to as initial periodic elementary trajectory, to another periodic elementary trajectory of the exoskeleton, referred to as final periodic elementary trajectory, is defined as a sequence of periodic elementary trajectories successively comprising the initial periodic elementary trajectory, at least one intermediate periodic elementary trajectory, and the final periodic elementary trajectory, the construction of the second database comprising, for each pair of an initial and of a final periodic trajectory of the first learning database, the determining of the at least one intermediate periodic elementary trajectory.

Each intermediate periodic elementary trajectory between an initial periodic elementary trajectory and a final periodic trajectory is a linear mixture of said initial and final periodic elementary trajectories.

Determining the at least one intermediate periodic elementary trajectory for a pair of an initial periodic elementary trajectory and of a final periodic trajectory uses a so-called shortest path algorithm from the initial periodic elementary trajectory to the final periodic trajectory in a graph of periodic elementary trajectories such that the cost for passing from one periodic elementary trajectory to another is representative of an inconsistency in the dynamics of the exoskeleton.

Step (b) further comprises the verification of a criterion representative of the accuracy of the predictions of the second neural network, and if this criterion is not verified the step (b) is repeated.

According to a second aspect, the invention relates to a method for generating a trajectory of an exoskeleton comprising steps of:
(c) storing in a memory of a second server parameters of a second neural network learnt using a method for learning parameters of a neural network for generating trajectories of the exoskeleton according to the first aspect;
(d) generating a trajectory of the exoskeleton by data processing means of the second server by using said second neural network.

According to other advantageous and non-limiting characteristics:

Said exoskeleton receives a human operator, the step (d) comprising the determining of a sequence of a n-tuple of walking parameters of the exoskeleton desired by said operator, and the trajectory of the exoskeleton is generated according to said sequence of n-tuples.

The generated trajectory of the exoskeleton comprises for each n-tuple of said sequence a new periodic elementary trajectory and a transition to this new periodic elementary trajectory.

According to a third aspect, the invention relates to a method for setting an exoskeleton in motion having a plurality of degrees of freedom of which at least one degree of freedom actuated by an actuator controlled by data processing means comprising a step (e) of executing by the data processing means of the exoskeleton a trajectory of the exoskeleton generated by means of the method for generating a trajectory of the exoskeleton according to the second aspect, in such a way as to make said exoskeleton walk.

According to a fourth aspect, the invention relates to a system comprising a first server, a second server and an exoskeleton each comprising data processing means, characterised in that said data processing means are configured to implement a method according to the first aspect for learning parameters of a neural network for generating trajectories of the exoskeleton, a method according to the second aspect for generating a trajectory of the exoskeleton, and/or a method according to the third aspect for setting the exoskeleton in motion.

According to a fifth and a sixth aspects, the invention relates to a computer program product comprising code instructions for the executing of a method according to the first aspect for learning parameters of a neural network for generating trajectories of an exoskeleton, a method according to the second aspect for generating a trajectory of an exoskeleton, and/or a method according to the third aspect for setting the exoskeleton in motion; and a means of storage that can be read by a piece of IT equipment whereon a computer program product comprises code instructions for the executing of a method according to the first aspect for learning parameters of a neural network for generating trajectories of an exoskeleton, a method according to the second aspect for generating a trajectory of an exoskeleton, and/or a method according to the third aspect for setting the exoskeleton in motion.

### PRESENTATION OF THE FIGURES

Other characteristics and advantages of the present invention shall appear when reading the following description of a preferred embodiment. This description will be given in reference to the accompanying drawings wherein:

FIG. 1 is a diagram of an architecture for the implementation of the methods according to the invention;

FIG. 2 is a diagram of an exoskeleton used by the methods according to the invention;

FIG. 3 is a diagram of a neural network used in the methods according to the invention;

FIG. 4 is a diagram showing a preferred embodiment of the methods according to the invention.

### DETAILED DESCRIPTION

### Architecture

According to three complementary aspects of the invention, the following are proposed: -p1 a method for learning parameters of a neural network, in particular of the FNN (Feedforward Neural Network) type for generating the trajectory of an exoskeleton 1;
a method for generating a trajectory of an exoskeleton 1 (using a neural network, advantageously learnt thanks to the aforementioned method); and
a method for setting an exoskeleton 1 in motion (applying a trajectory generated thanks to the method according to the second aspect).

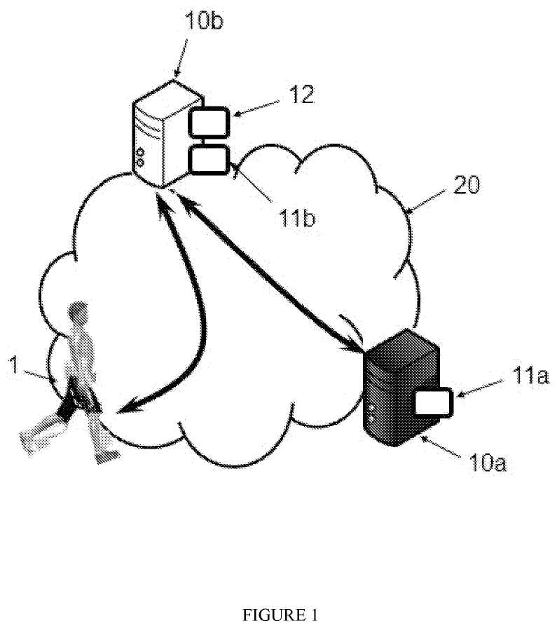

These three types of methods are implemented within an architecture such as shown in FIG. 1, thanks to a first and/or a second server 10a, 10b. The first server 10a is the learning server (implementing the first method) and the second server 10b is a server for generating trajectories (implementing the second method). It is entirely possible that these two servers are confounded, but in practice the first server 10a is a remote server while the second server 10b can be embedded by the exoskeleton 1 for operation in real time.

Each one of these servers 10a, 10b is typically a piece of IT equipment connected to a wide-area network 20 such as the internet network for exchanging data, although in practice once the neural network is learnt and embedded on the second server 10b the communication can be interrupted, at least intermittently. Each one comprises data processing means 11a, 11b of the processor type (in particular the data processing means 11a of the first server have high computing power, because the learning is long and complex compared to a simple use of the learnt neural network), and where applicable data storage means 12a, 12b such as a computer memory, for example a hard drive. On verra plus loin a learning database that can be stored by the memory 12a of the first server 10b.

According to a preferred embodiment that combines the three types of methods according to the invention, the system comprises the first server 10a connected to the exoskeleton 1 embedding said second piece of equipment 10b via the network 20:
the first server 10a uses its computational power to, where applicable, constitute two learning databases, then implement a method for learning parameters of a second neural network using these learning databases, and it transmits to the second server 1b the parameters learnt from the second neural network;
the second server 10b implements the method for generating a trajectory of the exoskeleton 1 thanks to a neural network using the parameters retrieved from the first server 10a;
the exoskeleton 1 directly applies said trajectory generated in situ for setting in motion.

It is understood that there can be a plurality of exoskeletons 1 each embedding their second server 10b (which can then be of limited power and space, in that it generates trajectories only for the exoskeleton 1 to which it is dedicated), or a plurality of exoskeletons 1 each connected to a second server 10b that is more powerful and optionally confounded with the first server 10a (and having the capacity of generating trajectories on the fly for all the exoskeletons 1).

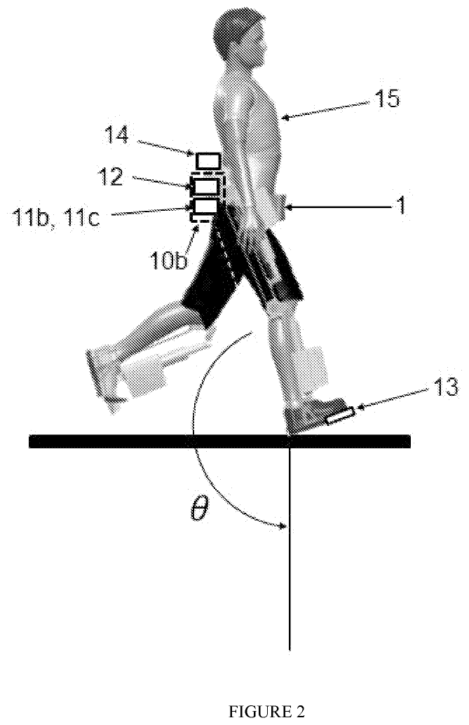

In reference to FIG. 2, the term exoskeleton 1 means an articulated mechanical system of the bipedal robotics device type, actuated and controlled, provided with two legs, receiving more precisely a human operator that has their lower limbs each attached to a leg of the exoskeleton 1 (in particular thanks to straps). It can thus be a more or less humanoid robot. “Walking” here means the setting into motion of the robotics device 1 in the broad sense, which results in practice in an alternating support on the legs, in the standing position (on flat ground, an inclined ramp, in a staircase, etc.), in such a way as to produce a displacement, but also a movement to pass from a sitting position to a standing position (movement referred to as “standing up”) or inversely.

The exoskeleton 1 has a plurality of degrees of freedom, i.e. deformable articulations (generally via a rotation) i.e. mobile in relation to one another, each one of which is either “actuated” or “not actuated”.

An actuated degree of freedom designates an articulation provided with an actuator controlled by data processing means 11c, i.e. this degree of freedom is controlled and it can be acted upon. On the contrary, a degree of freedom that is not actuated designates an articulation that is devoid of an actuator, i.e. this degree of freedom follows its own dynamics and the data processing means 11c do not have any direct control thereupon (but a priori an indirect control via the other actuated degrees of freedom). In the example of FIG. 1, the heel-ground contact is punctual, and the exoskeleton 1 is thus free in rotation with respect to this point of contact. The angle between the heel-hip axis and the vertical thus constitutes a degree of freedom that is not actuated.

The present exoskeleton naturally comprises at least one actuated degree of freedom, preferably a plurality, and also preferably at least one degree of freedom that is not actuated, i.e. it is said to be “under-actuated”, as mentioned hereinabove. The number of degrees of freedom that are not actuated is called degree of under-actuation.

The data processing means 11c designate a piece of IT equipment (typically a processor, either external if the exoskeleton 1 is “remote-controlled” but preferably embedded in the exoskeleton 1), where applicable confounded with the data processing means 11 b of the second server 10b if it is embedded (case shown in FIG. 2), and suitable for processing instructions and generating commands for the various actuators. The latter can be electrical, hydraulic, etc.

The exoskeleton 1 can further comprise a memory 12 (in particular that of the second server 10b, i.e. the means 12 can be external if the server 10b is not embedded), and various sensors such as means for detecting the impact of the feet on the ground 13, inertial measurement means 14, a sensor vest 15 of the operator, etc.

The present application shall not be limited to any exoskeleton 1 architecture, and the example shall be taken such as described in applications WO2015140352 and WO2015140353.

Thus, preferably and in accordance with these applications, the exoskeleton 1 comprises on each leg a foot structure comprising a supporting plane on which a foot of a leg of the person wearing the exoskeleton can bear against when the foot is flat.

This supporting plane comprises a front platform and a rear platform, such that a foot pivot connection connects the front platform to the rear platform, by constituting a degree of freedom that is not actuated. Such an architecture is particularly suited for trajectories of the “HZD” type.

Those skilled in the art will however know how to adapt the present method to any other mechanical architecture.

### Principle of the Invention

These last few years, there has been a keen interest for artificial intelligence techniques in the field of real-time control.

Unfortunately, the current process for generating trajectories is hardly compatible with methods of learning by reinforcement because there is no analytic gradient, which is required for the backpropagation of errors. Recourse is then required to more complex methods and which require more experimental data, which is expensive to obtain, such as Q-Learning and Policy Gradients. In addition, these methods do not make it possible to carry out the learning on an actual exoskeleton 1. Therefore, simulations have to be done.

Thus, although certain works in robotics makes use of neural networks to carry out planning tasks, the usage thereof is limited to non-linear regression, most often with the objective of compressing a database of trajectories and thus easily embedding it into a real device. This approach relegates the neural network to that status of a “black box” tool in the framework of research focussing on problems stemming from the field of traditional robotics rather than Machine Learning, offering little perspective for research. These works moreover have mitigated performance, because the trajectories are data that is difficult to model, the latter having many irregularities and a chaotic nature with regards to input parameters.

The present method cleverly resolves these difficulties by learning in fact successively two neural networks, designated as first and second neural network. The second neural network is the “output” network which effectively makes it possible to generate the trajectory of the exoskeleton.

As explained, “trajectory” of the exoskeleton means the changes in each degree of freedom (in particular actuated) expressed as a function of time or of a phase variable.

The idea is to define a “complex” trajectory as a sequence of periodic trajectories referred to as “elementary” intersected by transitions. The term periodic trajectory means any trajectory applied (where applicable repeatedly) over the duration of a step in such a way that starting from an initial state of the exoskeleton 1 at the beginning of a step (moment of contact of the foot), the same state is returned at the beginning of the following step (as explained this encompasses any flat walking, but also on a ramp, going up or down stairs, etc.). It is also said that the periodic trajectory forms a “limit cycle”. Thus, said periodic trajectory can be applied over any number of steps in a stable manner.

In other terms, each elementary trajectory is associated with a given walking of the exoskeleton 1 (a walking being defined by a n-tuple of walking parameters), and makes it possible to maintain this walking in a stable and feasible manner (i.e. as shall be seen respects all the constraints of an optimisation problem and minimises a cost function as much as possible). As explained, said walking parameters correspond to “characteristics” of the way of walking, such as the length of the steps, the walking frequency and the inclination of the bust, but also the height of the steps in case of negotiating stairs, the instantaneous angle of rotation for curved movements; and also to morphological characteristics of the operator (a subgroup of walking parameters referred to as patient parameters) such as their size, their weight, the lengths of the thighs or of the tibias, the position of the centre of mass (value of the shift towards the front) and the lateral deviation of the bust in the framework of rehabilitation activity.

Said “constraints” of walking mentioned hereinabove can be varied and depend on the type of walking desired, for example a “flat foot” walking, or “HZD”. The present method will not be limited to any type of desired walking.

The transitions correspond to changes in walking, i.e. variations in the values of said walking parameters (for example an increase in the length of the step): knowing an initial set of walking parameters and a final set of walking parameters, and therefore an initial periodic trajectory (associated with the initial set of walking parameters) and a final periodic trajectory (associated with the final set of walking parameters), said transition is a trajectory fragment that makes it possible to pass from the initial periodic trajectory to the final trajectory. Note that there can be “initial” or “final” transitions, for example a standing up or sitting down movement, but focus shall be given to the “intermediate” transitions between periodic trajectories, in that the initial or final transitions can be precalculated.

As shall be seen, such a transition is cleverly seen as a path in a space of periodic trajectories, i.e. one or more intermediate trajectories can be planned between an initial periodic trajectory and a final periodic trajectory, corresponding in particular to a “mixture” between these two trajectories, i.e. having intermediate walking parameters between these initial and final trajectories. In practice, a continuous set of possible intermediate periodic elementary trajectories can be available beforehand (all the trajectories by changing in particular linearly the walking parameters from one to the other of the initial and final trajectories), and the determining of transition trajectory consists of choosing the suitable succession of intermediate trajectories (advantageously parameterised by a function referred to as “progression” as shall be seen hereinafter). The number of these intermediate trajectories can be set and they are advantageously uniformly distributed, i.e. all of the possible intermediate trajectories form a continuous and linear succession.

In other terms, rather than passing instantly from an initial trajectory to a final trajectory, this proceeds in small increments over successive cycles. If the transition is sufficiently slow, then the impact of the progressive change in trajectory can be neglected. In other terms, the state of the system belongs practically to a limit cycle at each step.

The first neural network is able to predict walkings, i.e. generate a periodic elementary trajectory of the exoskeleton 1 for a given walking of the exoskeleton 1. In other terms, the first neural network takes as input an n-tuple of walking parameters and generates as output the corresponding periodic trajectory. The advantage is that this approach limits the number of dimensions, and therefore remains within the scope of current systems.

The second neural network is capable of generating periodic walkings identical to those obtained by the first neural network, but also to predict transitions that are physically permissible between the periodic walking cycles, i.e. to generate both periodic elementary trajectories and transitions, i.e. in the end any trajectory. It therefore generalises the first neural network and comes as a replacement.

Each one of the first and second networks is preferably a network of the FNN (Feedforward Neural Network) type, i.e. wherein the information flows in only one direction, forward, from the input nodes, passing through the hidden layers (where applicable) and to the output nodes, without recurrent connections, because such networks have excellent scalability. It is possible in particular to take an FNN with 2 or 3 hidden layers and 200 to 300 neurons per layer. Alternatively, other types of neural networks can be used such as convolutional neural networks (CNN), recurrent networks of the Long Short-Term Memory (LSTM) or Gated Recurrent Unit (GRU) type, etc.

Note that it is desirable that the first and/or the second neural network have a continuously derivable nature with respect to the walking parameters, and for this a network is preferred for example that uses an activation function of the sigmoid type, which is continuously derivable (in opposition to ReLU in particular).

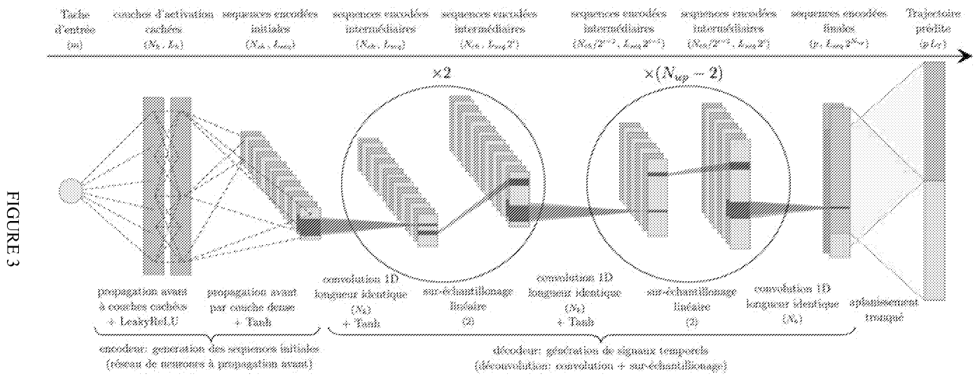

According to a particularly preferred embodiment shown in FIG. 3, each one of the first and second networks is advantageously an FNN that has a final block referred to as deconvolution (or transposed convolution) that uses alternatively convolution layers and upsampling layers. More precisely, this architecture forms a structure referred to as autoencoder (or “encoder-decoder”) wherein the main FNN block plays the role of an encoder by generating feature maps of small dimension, referred to as initial encoded sequences, and the deconvolution block plays the role of decoder by reconstructing the output sequence defining the trajectory predicted from the initial encoded sequences. This architecture makes it possible to have few parameters to be learnt because its structure naturally predicts time sequences correlated to each other, it is therefore not necessary to learn this zero behaviour as is the case with a conventional FNN.

### Method of Learning

According to a first aspect, the method for learning is proposed, implemented by the data processing means 11a of the first server 1a.

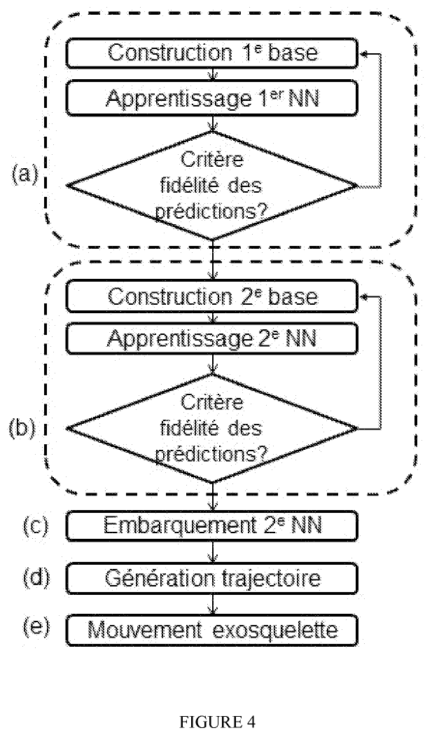

As explained and as shown in FIG. 4, the method begins with a step (a) of learning parameters of the first neural network able to generate a periodic elementary trajectory of the exoskeleton 1 for a given walking of the exoskeleton 1 defined by a n-tuple of walking parameters, according to a first database for learning periodic trajectories for a set of possible walkings of the exoskeleton 1.

Preferably, this step (a) comprises the construction of said first learning database, i.e. the generating of said periodic trajectories that constitute it.

The idea is to cover the set of possible walkings of the exoskeleton 1, i.e. to have for a large number of n-tuples of walking parameters, if possible well distributed, an associated trajectory.

As explained, optimisation tools are known for this, capable in particular of generating the first database of trajectories by optimisation over a compact space of the set of permissible research constituted of the various walking parameters. For example, in the case of HZD trajectories, the problem of generating trajectories is formulated in the form of an optimum control problem that can be resolved preferably by a so-called direct collocation algorithm, see the document Omar Harib et al., Feedback Control of an Exoskeleton for Paraplegics Toward Robustly Stable Hands-free Dynamic Walking.

The samples are advantageously randomly generated according to a uniform and discretised law over a finite set that has an identical number of possible values per parameter so as to guarantee a uniform covering of the complete space even for a small number of samples and include exactly its boundary. Mathematically, this means that for any given n-tuple of parameters there is a “close” sample.

Note that this step of constituting the first learning base is long but can be done far upstream, and the first base can be completed little by little. It is also possible to start with a pre-constructed base.

Regarding the learning of the first network in itself, it is possible to proceed in a conventional manner in particular by supervised learning, and at the end verify a criterion representative of the accuracy of the predictions of the neural network in order to validate the learning or not.

More rigorously, the prediction error must advantageously be significantly less than a maximum error of reference monitoring on the actual exoskeleton during a step on the average, i.e. less than a given faction (in particular 4%) of the predictions have a maximum error (in infinite standard, i.e. all articulations and all instants takes as a whole) of prediction greater than a threshold such as 0.01 rad.

If this is not the case, the trajectory-generating algorithm itself can be modified, in such a way as to encourage it to produce trajectories that are similar to a reference, corresponding in the present case to the predictions of the neural network.

A new first database is then preferably generated by following this methodology and the first neural network is retrained on this new base in a new occurrence of step (a), without reinitialising it, but rather incrementally with respect to its preceding state (i.e. we begin with the weights obtained at the end of the first occurrence of the step (a)). If the accuracy criterion of the predictions is still not verified, the process is reiterated.

At the end of the step (a), a first neural network capable of predicting periodic trajectories is available. These periodic trajectories are guaranteed to be feasible and stable, i.e. that satisfies all the constraints of the optimisation problem coming from the trajectory-optimising algorithm and that minimises the cost function of the original problem as much as possible. As explained, it is not possible to extend the proposed approach to the generating of transitions because the number of dimensions to be explored becomes too substantial.

It is understood that a large number (even an infinity) of feasible trajectories exists for a given task (i.e. that satisfy the constraints). The role of the optimisation process is to calculate the one that minimises a cost chosen from among the latter (energy in practice). However, all of these solutions are difficult to model by a neural network, that is why it is sought to restrict the optimisation problem solely to trajectories that can be perfectly modelled. Concretely, it is problem of consensus between all the trajectories of the database: the latter must agree with each other in order to be able to be modelled as a set, and thus guarantee predictions that are accurate and reliable (i.e. feasible/stable on the exoskeleton 1 for the training samples but also for test samples). It is here that the iterative method comes into play, because resolving this problem directly is impossible because it is too complex.

Thus, as explained the method then comprises a step (b) of learning, using parameters from the first neural network, parameters of a second neural network suitable for generating periodic elementary trajectories of the exoskeleton 1 and transitions from one periodic elementary trajectory of the exoskeleton 1 to another periodic elementary trajectory of the exoskeleton 1, according to a second learning database of periodic elementary trajectories and transitions for a set of possible walkings of the exoskeleton 1.

Preferably, the second neural network and the first neural network have as explained the same architecture (for example that of FIG. 3), but the second neural network comprises a larger number of parameters (for example by having more parameters by layer for an FNN, or more channels for a convolutional network for example), with the additional parameters able to be learnt during the step (b). The common parameters can optionally also be relearnt in the step (b) by starting with the values obtained in the step (a). Alternatively, the second neural network can correspond to the first neural network with additional layers with respect to the first network, of which the parameters will be learnt during the step (b).

It is understood in the same way that for the step (a), the step (b) can comprise the construction of said second learning database, i.e. the generating of said periodic trajectories and transitions that constitute it, and this advantageously from the first database. More precisely, all the transitions will be constructed from a so-called initial periodic trajectory of the first learning database to another so-called final periodic trajectory of the first learning database. Again, the second learning base can be constituted far upstream, completed little by little, and/or be pre-constructed.

As explained, a transition can be seen as a path in a space of periodic trajectories from an initial trajectory to a final trajectory, in such a way that said second base can contain, for each pair of initial and final periodic elementary trajectories of the first base (i.e. each pair of n-tuples of walking parameters, one designating the initial trajectory and the other the final trajectory) the transition from one to the other. Advantageously, all possible transitions are considered as equiprobable, regardless of the amplitude of the transition.

In practice, a heuristic method based solely on the periodic walking predictions can be proposed. The approach is as follows:

1. Generate a grid of periodic trajectories (which are as many possible intermediate trajectories) ranging from the initial periodic trajectory to the final trajectory by linearly varying the walking parameters. These intermediate trajectories correspond to a linear mixture between the two initial and final trajectories. As explained the number of intermediate trajectories can be set and they are advantageously uniformly distributed.

2. A transition corresponds to any path passing through this grid from the upper left corner (i.e. initial periodic trajectory at the initial time) to the lower right corner (final periodic trajectory at the final time). The transition considered as optimal among an infinite choice of possibilities can then be calculated using a so-called shortest path algorithm under constraints. By considering the grid as an undirected graph, i.e. the vertices of the graphs are periodic elementary trajectories (initial, final or intermediate), the cost associated with each transition from one vertex to another (travels of an edge, i.e. change in trajectory) corresponds to the “inconsistency” in the dynamics due to the transition from one periodic walking to another, the objective being to minimise the “inconsistency” of the transition over the entire trajectory. More precisely, it is desirable to avoid over the duration of the transition a change in trajectory that would have an excessively high impact risking the creation of an imbalance. The inconsistency corresponds mathematically to the violation of the equation of the dynamics along the transition trajectory: it is possible to use for example the residual error between the numerical derivative calculated from the transition trajectory and the expected term according to the equation of the dynamics. In practice, as explained, the travels in the grid can be parameterised by a function referred to as “progression”, that defines the progressive transition between the initial and final periodic trajectories, which can for example be parameterised by a polynomial the coefficients of which are optimised to minimise the inconsistency and respect the edge conditions thanks to said shortest path algorithm.

Regarding the learning of the second network itself, it is possible to conventionally proceed by minimising a cost function, and again at the end check said criterion representative of the accuracy of the predictions of the neural network in order to validate the learning or not.

At the end of the step (b), a first neural network capable of predicting complex trajectories (including transitions) is available. The second neural network (more particularly its learnt parameters) can then be embedded in a step (c) on the second server 10b (preferably on the exoskeleton 1).

### Method for Generating a Trajectory

According to a second aspect, the method for generating a trajectory of a trajectory of an exoskeleton 1 is proposed, implemented by the data processing means 11b of the second server 1b. Said method for generating a trajectory of a trajectory of an exoskeleton 1 follows the implementation of the method for learning according to the first aspect of the second neural network. More precisely, it begins with said step (c) of storing on a memory 12 of the second server 10b parameters of a second neural network learnt by means of the method for learning parameters of a neural network for generating trajectories of the exoskeleton 1.

As explained, the second neural network can have been generated well beforehand, be embedded on a large number of exoskeletons 1, etc. Preferably it is implemented in real time.

Said second method can be implemented regularly over the operation duration of the exoskeleton 1, and in particular comprises the optionally repeated call of the second neural network in such a way as to obtain periodic trajectories and/or transitions, in a step (d) for generating a trajectory of the exoskeleton 1 by data processing means 11 b of the second server 10b by using said second neural network

More precisely, a sequence of n-tuples of walking parameters progressively obtained is supposed (for example due to new commands from the operator of the exoskeleton). For each new n-tuple of parameters, the second neural network determines a new periodic trajectory and a transition towards this new periodic trajectory.

For this, the method for generating a trajectory advantageously comprises the determining (where applicable regularly repeated) of the n-tuple of walking parameters of the exoskeleton 1.

Indeed, if the exoskeleton 1 is an exoskeleton receiving a human operator, it is the posture of said human operator (and optionally the pressing of buttons) that determines said parameters (contrary to the case of a normal robot that can directly receive a start-up request comprising a setpoint for the speed and/or direction of walking).

For this, the operator can be provided as explained with a sensor vest 15 that makes it possible to detect the configuration of their bust (orientation of the latter). The direction in which the operator orients their bust is that in which they wish to walk and the speed is given by the intensity with which they place their bust forward (to the extent the operator leans over). The start-up request can correspond to the operator pressing a button (or a particular posture) signalling their intention to start walking and therefore commanding the data processing means to determine said parameters. Some parameters such as the instantaneous angle of rotation or the height of the steps in case of negotiating stairs can be predetermined or obtained by means of other sensors 13, 14.

According to a third aspect, a method for setting an exoskeleton 1 in motion is proposed comprising the implementation of said method according to the second aspect for generating a trajectory of the exoskeleton (step (a), (b), (c), (d)), then (in a step noted as (e)) the execution of said trajectory in such a way that the exoskeleton 1 walks.

Steps (d) and (e) can be repeated in such a way as to correct the trajectory of the exoskeleton 1 always in real time.

### Equipment and System

According to a fourth aspect, the invention relates to the system, for the implementation of the methods according to the first and second and/or the third aspect.

As explained, this system comprises a first server 10a, a second server 10b and an exoskeleton 1, possibly confounded.

The first server 10a comprises data processing means 11a for the implementation of the method according to the first aspect.

The second server 10b comprises data processing means 11b for the implementation of the method according to the second aspect, and generally data storage means 12 for the storage of the second neural network (or rather its learnt parameters).

The exoskeleton 1 comprises data processing means 11c configured for the implementation of the method according to the third aspect, as well as if necessary data storage means 12 (in particular those of the second server 10b), inertial measurement means 14 (inertial measurement unit), means for detecting the impact of the feet on the ground 13 (contact sensors or optionally pressure sensors), and/or a sensor vest 15.

It has a plurality of degrees of freedom of which at least one degree of freedom actuated by an actuator controlled by the data processing means 11c in the framework of implementing the method according to the third aspect.

### Computer Program Product

According to a fifth and a sixth aspects, the invention relates to a computer program product comprising code instructions for the execution (on the processing means 11a, 11b, 11c), of a method according to the first aspect of learning parameters of a neural network, of a method according to the second aspect for generating a trajectory of an exoskeleton 1 and/or of a method according to the third aspect for setting the exoskeleton 1 in motion, as well as means of storage that can be read by a piece of IT equipment on which this computer program product is found.

1. Method for learning parameters of a neural network for generating trajectories of an exoskeleton, the method comprising the implementation, by a data processor of a first server, of steps of:
(a) Learning parameters of a first neural network suitable for generating periodic elementary trajectories of the exoskeleton each for a given walking of the exoskeleton defined by a n-tuple of walking parameters, according to a first learning database of periodic trajectories for a set of possible walkings of the exoskeleton; and
(b) Learning, using parameters from the first neural network, parameters of a second neural network suitable for generating periodic elementary trajectories of the exoskeleton and transitions from one periodic elementary trajectory of the exoskeleton to another periodic elementary trajectory of the exoskeleton, according to a second learning database of periodic elementary trajectories and transitions for a set of possible walkings of the exoskeleton.

2. Method according to claim 1, wherein the step (a) comprises the construction of said first learning database of periodic trajectories for a set of possible walkings of the exoskeleton by using an optimisation algorithm.

3. Method according to claim 2, wherein said set of possible walkings of the exoskeleton is chosen in such a way as to uniformly cover the space wherein said n-tuple of walking parameters has value.

4. Method according to claim 2, wherein the step (a) further comprises the verification of a criterion representative of the accuracy of the predictions of the first neural network, and if this criterion is not verified the step (a) is repeated.

5. Method according to claim 1, wherein the step (b) comprises the construction of said second learning database of periodic trajectories and transitions for a set of possible walkings of the exoskeleton, using the first learning database.

6. Method according to claim 5, wherein said second learning database comprises all the transitions from a periodic elementary trajectory of the exoskeleton of the first learning database to another periodic elementary trajectory of the exoskeleton of the first learning database.

7. Method according to claim 6, wherein each transition of a periodic elementary trajectory of the exoskeleton, referred to as initial periodic elementary trajectory, to another periodic elementary trajectory of the exoskeleton, referred to as final periodic elementary trajectory, is defined as a sequence of periodic elementary trajectories successively comprising the initial periodic elementary trajectory, at least one intermediate periodic elementary trajectory, and the final periodic elementary trajectory, the construction of the second learning database comprising, for each pair of an initial and of a final periodic trajectory of the first learning database, the determining of the at least one intermediate periodic elementary trajectory.

8. Method according to claim 7, wherein each intermediate periodic elementary trajectory between an initial periodic elementary trajectory and a final periodic trajectory is a linear mixture of said initial and final periodic elementary trajectories.

9. Method according to claim 7, wherein the determining of the at least one intermediate periodic elementary trajectory for a pair of an initial periodic elementary trajectory and of a final periodic trajectory uses a so-called shortest path algorithm from the initial periodic elementary trajectory to the final periodic trajectory in a graph of periodic elementary trajectories such that the cost for passing from one periodic elementary trajectory to another is representative of an inconsistency in the dynamics of the exoskeleton.

10. Method according to claim 5, wherein the step (b) further comprises the verification of a criterion representative of the accuracy of the predictions of the second neural network, and if this criterion is not verified the step (b) is repeated.

11. Method for generating a trajectory of an exoskeleton comprising steps of:
(c) storing in a memory of a second server parameters of a second neural network learnt using a method for learning parameters of a neural network for generating trajectories of the exoskeleton according to claim 1;
(d) generating a trajectory of the exoskeleton by a data process or of the second server by using said second neural network.

12. Method according to claim 11, wherein said exoskeleton receives a human operator, wherein the step (d) determining a sequence of n-tuples of walking parameters of the exoskeleton desired by said operator, and the trajectory of the exoskeleton is generated according to said sequence of n-tuples.

13. Method according to claim 12, wherein the generated trajectory of the exoskeleton comprises for each n-tuple of said sequence a new periodic elementary trajectory and a transition to this new periodic elementary trajectory.

14. Method for setting an exoskeleton in motion having a plurality of degrees of freedom of which at least one degree of freedom actuated by an actuator controlled by a data processor of the exoskeleton, the method comprising a step (e) of executing by the data processor of the exoskeleton a trajectory of the exoskeleton generated by using the method for generating a trajectory of the exoskeleton according to claims 11, so as to make said exoskeleton walk.

15. A system comprising
a first server comprising a first data processor,
a second server comprising a second data processor,and
an exoskeleton comprising a third data processor,
the first data processor being configured to:
(a) learn parameters of a first neural network suitable for generating periodic elementary trajectories of the exoskeleton each for a given walking of the exoskeleton defined by a n-tuple of walking parameters, according to a first learning database of periodic trajectories for a set of possible walkings of the exoskeleton; and
(b) learn, using parameters from the first neural network, parameters of a second neural network suitable for generating periodic elementary trajectories of the exoskeleton and transitions from one periodic elementary trajectory of the exoskeleton to another periodic elementary trajectory of the exoskeleton, according to a second learning database of periodic elementary trajectories and transitions for a set of possible walkings of the exoskeleton.

16. (canceled)

17. A non-transitory storage medium comprising code instructions executable by a computing device, wherein when executed the code instructions cause the computing device to at least:
(a) learn parameters of a first neural network suitable for generating periodic elementary trajectories of an exoskeleton each for a given walking of the exoskeleton defined by a n-tuple of walking parameters, according to a first learning database of periodic trajectories for a set of possible walkings of the exoskeleton; and
(b) learn, using parameters from the first neural network, parameters of a second neural network suitable for generating periodic elementary trajectories of the exoskeleton and transitions from one periodic elementary trajectory of the exoskeleton to another periodic elementary trajectory of the exoskeleton, according to a second learning database of periodic elementary trajectories and transitions for a set of possible walkings of the exoskeleton.

18. The system of claim 15, wherein the second data processor is configured to at least:
(c) store in a memory of the second server parameters of the second neural network; and
(d) generate a trajectory of the exoskeleton of the second server by using the second neural network.

19. The system of claim 18, wherein the exoskeleton has a plurality of degrees of freedom of which at least one degree of freedom is actuated by an actuator controlled by the third data processor, and wherein the third data processor is configured to at least set the exoskeleton into motion by executing the trajectory of the exoskeleton so as to make the exoskeleton walk.

20. The non-transitory storage medium of claim 17, wherein, when executed, the code instructions cause the computer to at least:
(c) store, in a memory of a second server, parameters of the second neural network; and
(d) generate a trajectory of the exoskeleton by using the second neural network.

21. The non-transitory storage medium of claim 22, wherein the exoskeleton has a plurality of degrees of freedom of which at least one degree of freedom is actuated by an actuator controlled by the computer, and when executed, the code instructions cause the computer to at least set the exoskeleton into motion by executing the trajectory of the exoskeleton so as to make the exoskeleton walk.
